(19) United States
(12) Patent Application Publication
(10) Pub. No.: US 2022/0408031 A1
(43) Pub. Date: Dec. 22, 2022

(54) Systems and Methods for Video Editing and Effects

(71) Applicants: Meta Platforms, Inc., Menlo Park, CA (US); Meta Platforms Technologies, LLC, Menlo Park, CA (US)

(72) Inventors: Michelle Jia-Ying CHEUNG, Cupertino, CA (US); Sammy EL GHAZZAL, Oberengstringen (CH); Caley DROOFF, San Francisco, CA (US); Michael Donghee CHANG, San Francisco, CA (US)

(73) Assignee: Meta Platforms, Inc.

(21) Appl. No.: 17/821,619

(22) Filed: Aug. 23, 2022

Related U.S. Application Data
(60) Provisional application No. 63/298,407, filed on Jan. 11, 2022.
(60) Provisional application No. 63/298,411, filed on Jan. 11, 2022.
(60) Provisional application No. 63/293,389, filed on Dec. 23, 2021.

(51) Int. Cl. H04N 5/272; G06F 3/01; G06T 7/20; G06V 40/20

(52) U.S. Cl. CPC H04N 5/272; G06F 3/013; G06T 7/20; G06V 40/20

(57) ABSTRACT

Aspects of the disclosed technology can determine when a user has made a gesture mapped to an effect and can display the effect on the video. Additional aspects of the disclosed technology can automatically match movements between a source video and a live feed of a user. Yet further aspects of the disclosed technology can customize a video based on a determined focus of the video creator.

### CROSS REFERENCE TO RELATED APPLICATIONS

This application claims priority to U.S. Provisional Application Nos. 63/293,389 filed Dec. 23, 2021, titled “Video Customizations From Creator Focus Indications,” with Attorney Docket Number 3589-0108DP01; 63/298,411 filed Jan. 11, 2022, titled “Automated Movement Matching Between Videos,” with Attorney Docket Number 3589-0099DP01; and 63/298,407 filed Jan. 11, 2022, titled “Gesture Triggering Video Effects,” with Attorney Docket Number 3589-0098DP01. Each patent application listed above is incorporated herein by reference in their entireties.

### BACKGROUND

There are many different video and image editing systems allowing users to create sophisticated editing and compilation effects. With the right equipment, software, and commands, a user can apply effects to produce nearly any imaginable visual result. However, video editing typically requires complicated editing software that can be very expensive, difficult to use, and, without significant training, is unapproachable for the typical user.

### SUMMARY

Aspects of the present disclosure are directed to a gesture video effect system that can determine when a user has made a gesture that is mapped to an effect and can display the effect, e.g., as an overlay on the video. The gesture can be from a pre-defined set of gestures or a gesture specified by the effect creator. In various cases, the gesture can be recognized using a trained machine learning model that recognizes gestures or that can compare a kinematic model of a depicted user to a kinematic model for a gesture to determine a match. A selected effect can be displayed as a video overlay at a location corresponding to where the gesture was made or at another location defined by the effect creator.

Further aspects of the present disclosure are directed to a movement matching system that can automatically match movements between a source video and a live feed of a user. The movement matching model can do this by initially tracking a first user depicted in a source video. The movement matching model can then generate a corresponding set of kinematic model movements for that first user. The movement matching model can next provide an overlay on a second video with the same soundtrack according to the kinematic model movements. Finally, the movement matching model can track movements of a second user and determine how accurately they match the set of kinematic model movements.

Yet further aspects of the present disclosure are directed to a video customization system that can capture both video data and gaze data indicating where the video creator is looking throughout the video. The video customization system can correlate the gaze data to coordinates in the video. Based on these coordinates, the video customization system can perform various customizations on the video, such as setting the coordinates as the focal point of the video, recognizing an object at the coordinates and setting that object as a focus object and/or highlighting the focus object, and/or setting a creator's field-of-view in the video.

### BRIEF DESCRIPTION OF THE DRAWINGS

FIG. 1 is an example of a video frame in which a user is depicted making a kicking gesture.

FIG. 2 is an example of an effect overlaid on a video frame.

FIG. 3 is an example of a video frame in which a user is depicted making a punch gesture that maps a “POW!” effect.

FIG. 4 is an example where a user continues to extend her arm further making the punch gesture, and the effect is enlarged and moves according to the location of the punch gesture.

FIG. 5 is a flow diagram illustrating a process used in some implementations for determining when a user has made a gesture mapped to an effect and displaying the effect as an overlay on the video.

FIG. 6 is a conceptual diagram illustrating an example of mapping a kinematic model onto a depiction of a user.

FIGS. 7 and 8 are examples of an overlay on a second video, provided according to determined kinematic model movements of a user in a source video.

FIG. 9 is an example of a score and leveling provided according to an accuracy of a user's movements to a provided indication of kinematic model movements.

FIG. 10 is a conceptual diagram illustrating an example of mapping a kinematic model onto a depiction of a user.

FIG. 11 is a flow diagram illustrating a process used in some implementations for automatically matching movements between a source video and a live feed of a user.

FIGS. 12A and 12B illustrate an example of video frames with a point focus based on a creator's gaze.

FIG. 13 is an example of a video frame with an object focus based on a creator's gaze.

FIG. 14 is an example of a video frame with a field-of-view set based on a creator's field-of-view.

FIG. 15 is a flow diagram illustrating a process used in some implementations for customizing a video based on a determined focus of the video creator.

FIG. 16 is a block diagram illustrating an overview of devices on which some implementations of the disclosed technology can operate.

FIG. 17 is a block diagram illustrating an overview of an environment 1700 in which some implementations of the disclosed technology can operate.

### DESCRIPTION

Aspects of the present disclosure are directed to a gesture video effect system that can determine when a user has made a gesture mapped to an effect and can implement the effect in the video. In various implementations, the gesture can be one of a pre-defined set of gestures, selected by the effect creator, or can be a unique gesture specified by the effect creator (e.g., by making a pose in front of a camera or by posing a virtual user model, which the gesture video effect system saves for comparison to depictions of poses made by users in videos). In various cases, the gesture can be recognized using a machine learning model trained to recognize gestures and/or by mapping a kinematic model to the depicted user and applying a machine learning model trained to demine a similarity between the kinematic model and a kinematic model defined for the gesture. Also in various implementations, once the effect is selected as mapped to a gesture that was performed by a depicted user, the effect can be displayed at one of various locations, such as at a location corresponding to where the gesture was made or at a location define by the effect creator (e.g., at particular coordinates in the video frame or in relation to a recognized object or body part depicted in the video frame).

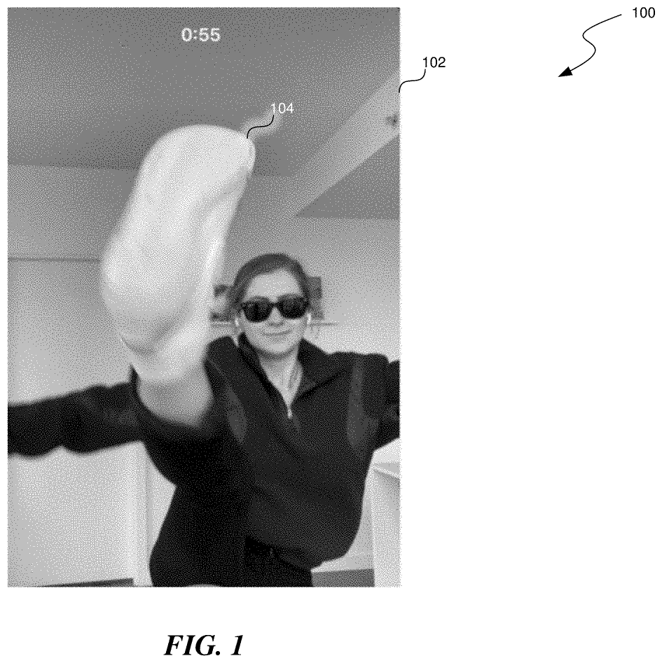

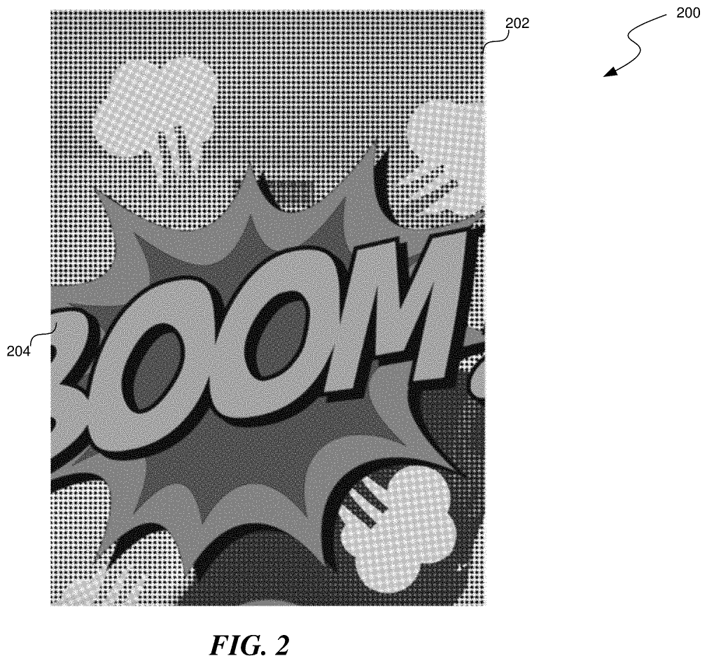

FIG. 1 is an example 100 of a video frame 102 in which a user is depicted making a kicking gesture 104. In example 100, an effect has been defined that maps the kicking gesture 104 to an effect. The effect is shown in example 200 of FIG. 2, in which the effect 204 is overlaid on the video frame 202. In example 200, the effect 204 is a full-frame effect showing a “BOOM!” animation with a background that grays out the rest of the frame. Because the effect 204 is a full-frame effect, no specific location for the effect needs to be determined.

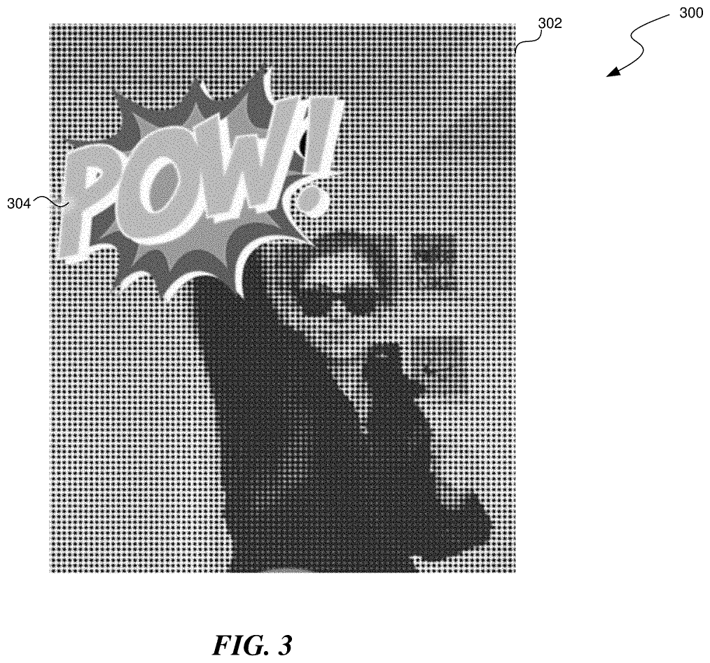

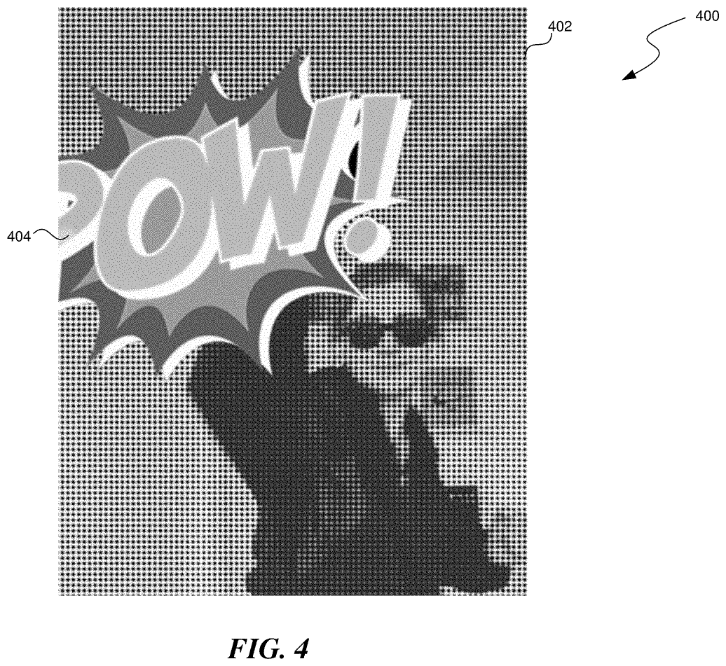

FIG. 3 is an example 300 of a video frame 302 in which a user is depicted making a punch gesture that maps the “POW!” effect 304. The effect 304 is overlaid on the video frame 302. In example 300, the effect 304 is configured to be displayed at a location in the video frame 302 at which the gesture has been recognized. Further, the punch gesture is a gesture that is recognized based on both pose and motion of the user, thus it can be recognized across multiple video frames and the location of the gesture in the video frame can move as the user completes the gesture. This is depicted in example 400 of FIG. 4, where the user continues to extend her arm further making the punch gesture, and the effect 404 is enlarged and moves (from effect 304) according to the location of the punch gesture in frame 402.

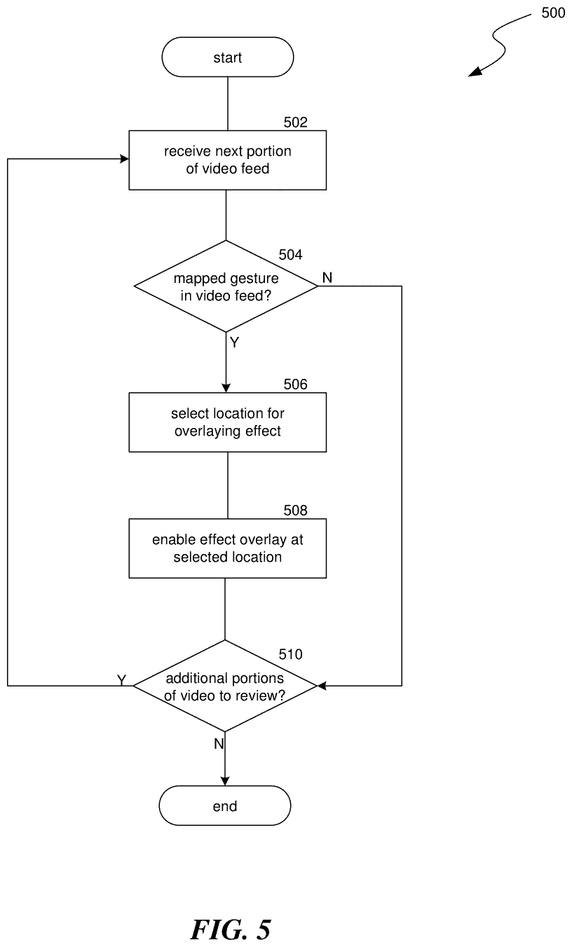

FIG. 5 is a flow diagram illustrating a process 500 used in some implementations for determining when a user has made a gesture mapped to an effect and displaying the effect as an overlay on the video. In some implementations, process 500 can be performed in response to a user viewing a live video stream or as part of a post-processing procedure for a recorded video.

At block 502, process 500 can receive a next portion of a video feed. In various implementations, the portion of the video feed can be a latest portion of a live video feed or a next portion of a pre-recorded video feed received for post-processing. In some cases, when the video is being recorded, the gesture video effect system can include an affordance illustrating to the user what gestures the user can make to cause effects. For example, the gesture video effect system can put an overlay on the video showing a pose mapped to an effect, can provide a tutorial, can show an icon or description indicating mapped gestures, or can provide another instruction.

At block 504, process 500 can determine whether a gesture, mapped to an effect, is in the video feed. While any user movement or pose can be a gesture mapped to an effect, examples of possible gestures include a defined number of fingers raised, a hand raised, a punch, a kick, a waive, a head nod, a particular facial expression (e.g., a smile, mouth open, tongue out, a frown, etc.), a twirl, a jump, etc. The particular gesture that is mapped to an effect can be specified by the effect creator. For example, the effect creator can select a gesture from a pre-defined set of gestures, can pose a virtual user model, or can make a gesture in front of a capture camera. As a first example, the effect creator can have a virtual model of a user that can be moved to make a gesture (pose and/or movement) on a computing system. When the effect creator causes the model to make the gesture, a corresponding kinematic model for the gesture (which can be a pose of the model or the model in motion) can be tracked and saved as the gesture. As a second example, the effect creator can appear in front of a capture camera and perform the gesture (pose and/or movement) that she wants mapped to the effect. The gesture video effect system can determine a corresponding kinematic model for the performed gesture, which it can save as the gesture for the effect.

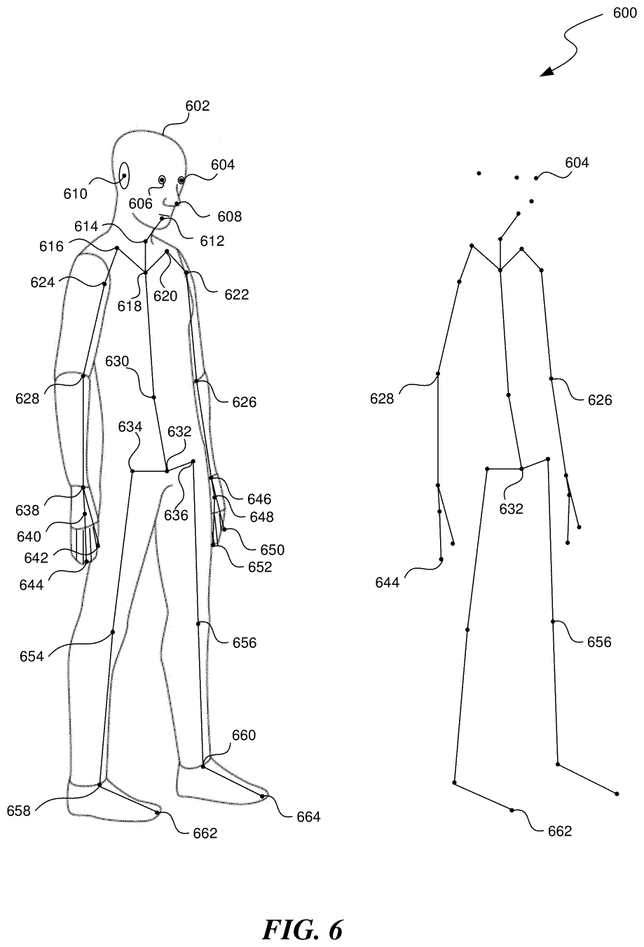

For the set of effects mapped to gestures, process 500 can determine whether one of these gestures is being performed using various machine learning approaches. For example, a machine learning model can be trained to define a kinematic model for the user depicted in one or more video frames. Such a kinematic model (also known as a skeletal model) can identify key points on a depicted user's body, such as at their forehead, chin, base of neck, shoulders, elbows, wrists, palms, fingertips, torso, hips, knees feet, and tips of toes. In various implementations, more or less points can be used (e.g., additional points on a user's face can be mapped to determine more fine-grained facial expressions). Kinematic models are discussed in greater detail below in relation to FIG. 6. This kinematic model can be compared (e.g., thorough distance comparisons or with another trained model) to a kinematic model defined for the gestures to determine if they are similar enough to conclude the user is making the gesture. In various cases, a gesture can be the entire kinematic model or can be part, such as the part corresponding to a user's hand and arms, legs, or head. For example, a gesture can be recognized when the kinematic model matches the user raising her hand, no matter what other actions the user is doing with other body parts. In other cases, a machine learning model can be trained to directly take video frames and return a result of whether the user is making one of a set of pre-defined gestures. In some cases, where a defined gestures includes a movement (as opposed to only a user posture), the determination made at block 504 may be over a series of video frames to determine if the user is making the defined movement.

If a mapped gesture is recognized, process 500 can proceed to block 506; otherwise process 500 can proceed to block 510.

At block 506, process 500 can select a location for overlaying or otherwise applying the effect to the video feed. In some cases, the effect can be a full-frame effect, in which case the location is just the entire frame. In other cases, the effect can be configured to be placed in relation to the location in the frame of where the user made the gesture. In some cases, this location can be updated as the user continues to make the gesture across frames (e.g., causing the effect to move with the gesture). In yet other cases, the effect can have a defined location (e.g., specified by the effect creator), such as at an x-y offset from a corner of the frame or in relation to a recognized object or body part depicted in the frame (whether or not this object or body part was part of the recognized gesture).

At block 508, process 500 can enable the effect on video at selected location. This can include adding a sticker, playing an animation, adding shading, applying a warping, or any other possible video effect (which may or may not be an overlay). In some cases, adding the effect can be part of a post-processing procedure, in which case multiple effects may be mapped to the same gesture and the user can select which of several effects to apply.

At block 510, process 500 can determine whether there are additional portions of the video to review. For a live feed, this can include determining whether the live feed has ended. For a pre-recorded video, this can include determining whether there are additional portions of the pre-recorded video remaining. If there are additional portions of the video to review, process 500 can return to block 502; otherwise process 500 can end.

FIG. 6 is a conceptual diagram illustrating an example 600 of mapping a kinematic model onto a depiction of a user. On the left side, example 600 illustrates points defined on a body of a user 602 while these points are again shown on the right side of FIG. 6 without the corresponding person to illustrate the actual components of a kinematic model. These points include eyes 604 and 606, nose 608, ears 610 (second ear point not shown), chin 612, neck 614, clavicles 616 and 620, sternum 618, shoulders 622 and 624, elbows 626 and 628, stomach 630, pelvis 632, hips 634 and 636, wrists 638 and 646, palms 640 and 648, thumb tips 642 and 650, fingertips 644 and 652, knees 654 and 656, ankles 658 and 660, and tips of feet 662 and 664. In various implementations, more or less points are used in a kinematic model (e.g., additional points on a user's face can be mapped to determine more fine-grained facial expressions). Some corresponding labels have been put on the points on the right side of FIG. 6, but some have been omitted to maintain clarity. Points connected by lines show that the kinematic model maintains measurements of distances and angles between certain points. Because points 604-610 are generally fixed relative to point 612, they do not need additional connections.

Aspects of the present disclosure are directed to a movement matching system that can automatically match movements between a source video and a live feed of a user. The movement matching model can use a machine learning model trained to recognize points on a first user depicted in the source video to label those points and map the first user's poses to a kinematic model. The movement matching model can then track the kinematic model across frames of the source video to get a set of kinematic model movements for the first user in the source video. In various implementations, the set of kinematic model movements can be for the entire source video or for key points, such as at certain beats or at certain intervals. The movement matching model can next provide an overlay on a second video, that has the same soundtrack, according to the kinematic model movements. This can be an overlay showing an outline of a person drawn around the kinematic model. In various implementations, the second video can be the same as the first video, a feed of a second user, or another video such as one that depicts the second user in a new environment such as on a stage or in a music video. The movement matching model can next track movements of a second user in a live feed, by again applying the machine learning model trained to recognize points on a depicted user and map those points to a kinematic model. Finally, the movement matching model can determine how accurately the second user's movements match the set of kinematic model movements from the source video, e.g., by determining distances between matched points of the two kinematic models or by applying another machine learning model trained to take two kinematic models and provide a match value.

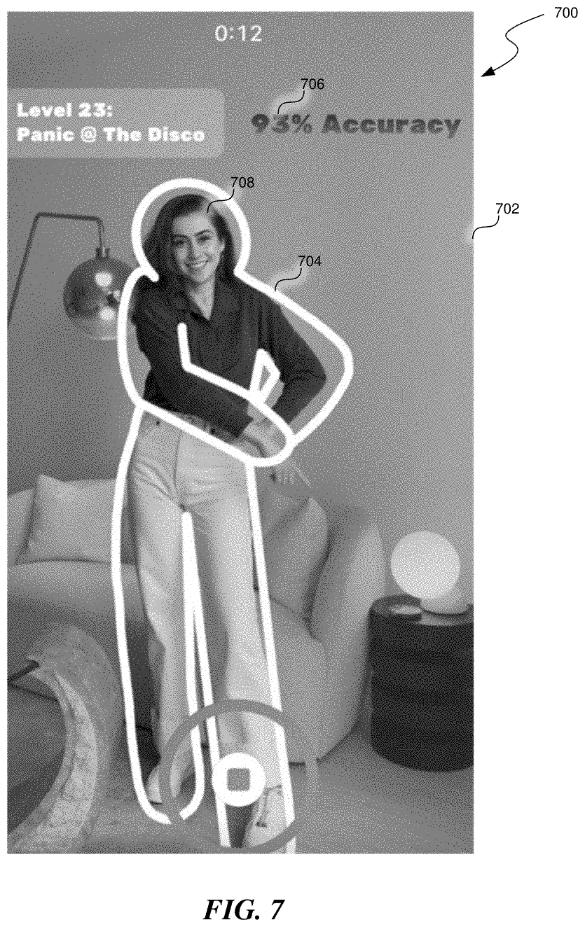

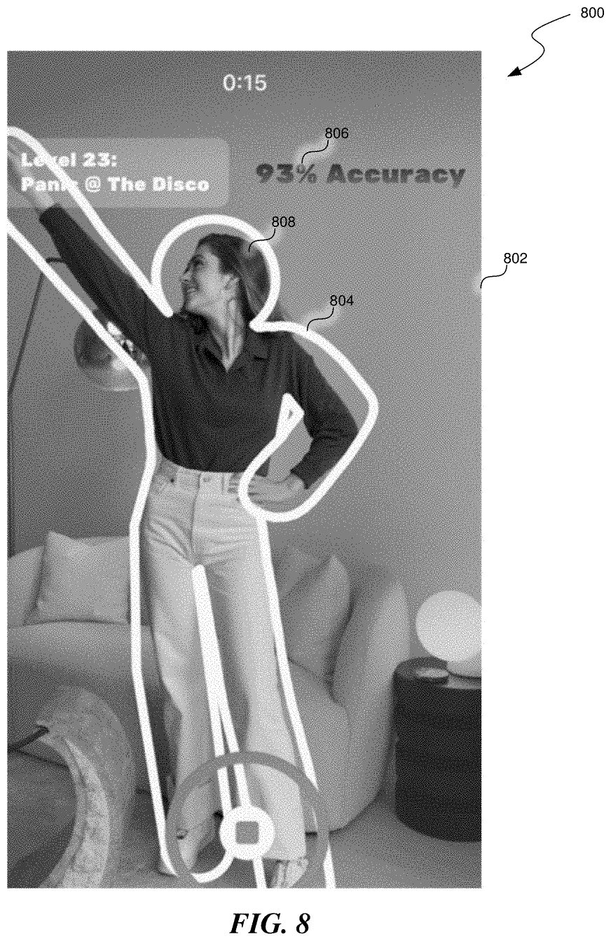

FIGS. 7 and 8 are examples 700 and 800 of an overlay on a second video, provided according to determined kinematic model movements of a user in a source video. Examples 700 and 800 include video frames 702 and 802 in which overlays 704 and 804 have been shown on a feed depicting a second user. The overlays 704 and 804 are based on a kinematic model of first user depicted in a source video, where the source video and the feed have a same song playing. The timing of the overlays 704 and 804 are coordinated according to the song, such that kinematic model movements from the source video that occur for portions of the song have corresponding overlays when those same portions of the song are in the feed. Also in examples 700 and 800, the movement matching model is tracking a second kinematic model for the depicted user 708 and 808 and determining how well that second kinematic model matches the kinematic model from the source video. Accuracy scores 706 and 806 are provided showing the results of this matching.

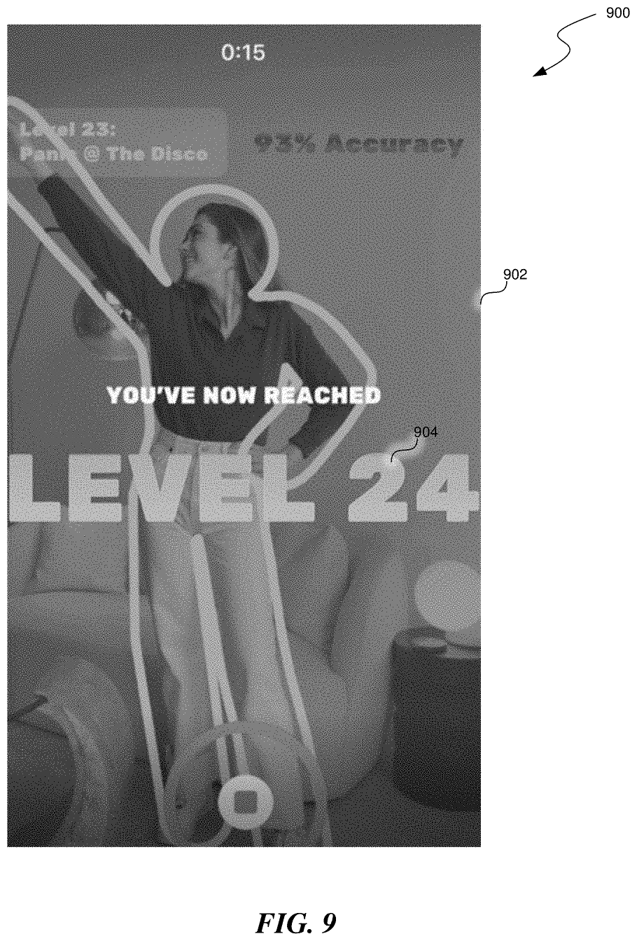

FIG. 9 is an example 900 of a score and leveling provided according to an accuracy of a user's movements to a provided indication of kinematic model movements. Example 900 illustrates a frame of the feed 902 in which an overlay has been applied indicating to the user that she has reached a next level. In examples 700-900, the movement matching model is presenting a game interface whereby the user achieves levels by having above a threshold accuracy score (e.g., scores 706 and 806) for a threshold amount of time. In example 900, the user has progressed to level 24, as indicated by display 904.

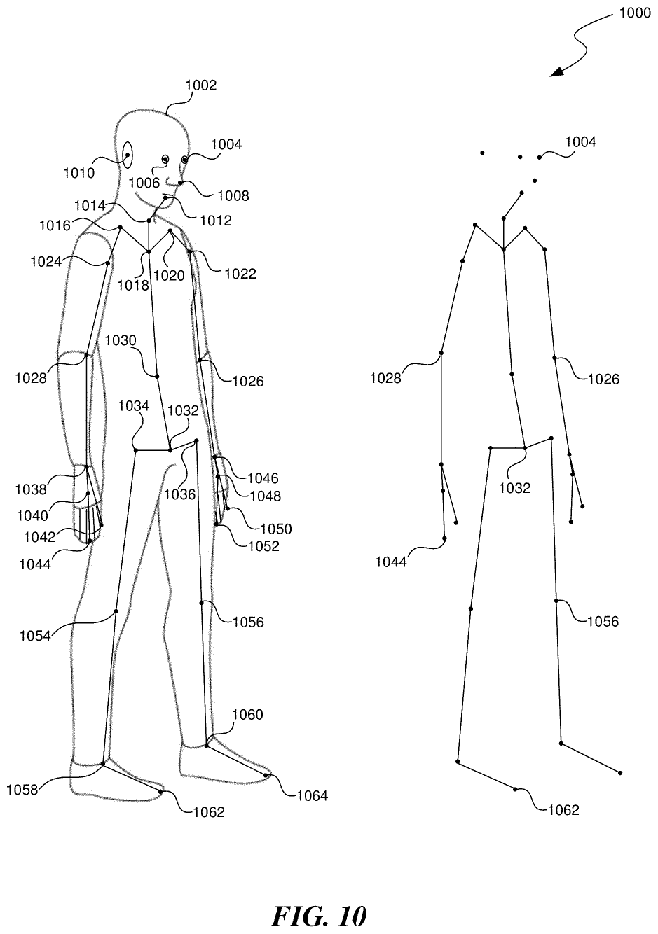

FIG. 10 is a conceptual diagram illustrating an example 1000 of mapping a kinematic model onto a depiction of a user. On the left side, example 1000 illustrates points defined on a body of a user 1002 while these points are again shown on the right side of FIG. 10 without the corresponding person to illustrate the actual components of a kinematic model. These points include eyes 1004 and 1006, nose 1008, ears 1010 (second ear point not shown), chin 1012, neck 1014, clavicles 1016 and 1020, sternum 1018, shoulders 1022 and 1024, elbows 1026 and 1028, stomach 1030, pelvis 1032, hips 1034 and 1036, wrists 1038 and 1046, palms 1040 and 1048, thumb tips 1042 and 1050, fingertips 1044 and 1052, knees 1054 and 1056, ankles 1058 and 1060, and tips of feet 1062 and 1064. In various implementations, more or less points are used in a kinematic model (e.g., additional points on a user's face can be mapped to determine more fine-grained facial expressions). Some corresponding labels have been put on the points on the right side of FIG. 10, but some have been omitted to maintain clarity. Points connected by lines show that the kinematic model maintains measurements of distances and angles between certain points. Because points 1004-1010 are generally fixed relative to point 1012, they do not need additional connections.

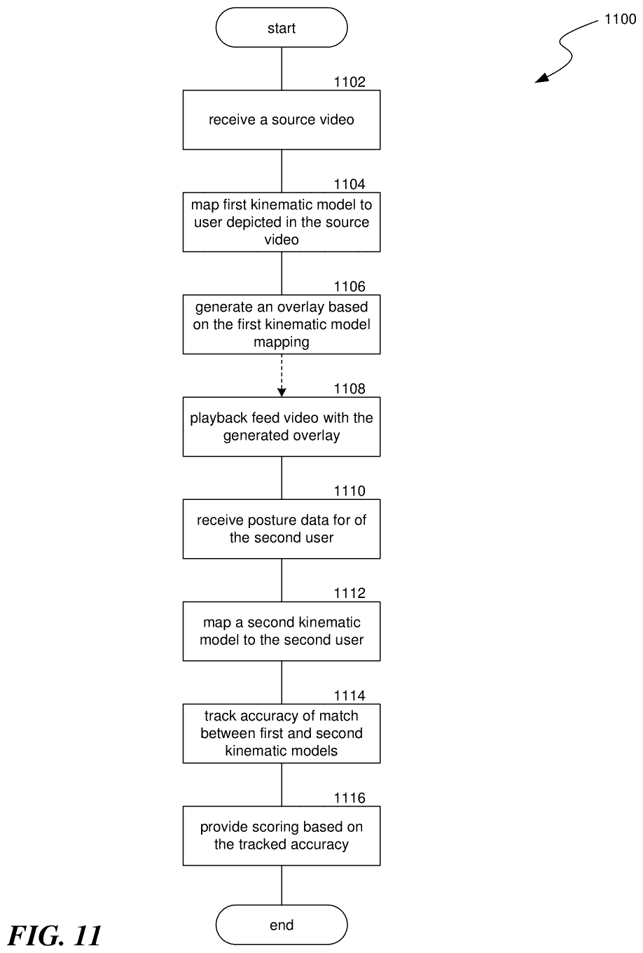

FIG. 11 is a flow diagram illustrating a process 1100 used in some implementations for automatically matching movements between a source video and a live feed of a user. In some implementations, process 1100 can be performed on a client device or on a server system. Process 1100 can be performed, for example, in response to a user designating a video as a source video for which movement matching should be enabled.

At block 1102, process 1100 can receive a source video. This can be a pre-recorded video or live video depicting a first user taking actions, such as dancing to music.

At block 1104, process 1100 can map a first kinematic model to the first user depicted in the source video received at block 1102. In various implementations, this mapping can be for all frames of the source video or for just certain points, such as when certain beats occur (e.g., downbeats or upbeats in the music of the video) or at certain intervals (e.g., every 1, 5, or 10 seconds) of the video.

At block 1106, process 1100 can generate an overlay based on the first kinematic model mapping. This overlay can be for the whole source video or for the parts of the source video for which the first kinematic model was specified. Generating the overlay can include showing all or a part of the first kinematic model or drawing a person-shaped outline around the pose of the first kinematic model. Examples of such outlines are provided in FIGS. 7 and 8.

The line connecting block 1106 and 1108 is shown as a dashed line to illustrate that block 1108 may not be triggered by the completion of block 1106 and that blocks 1102-1106 and blocks 1108-1116 may be performed on different systems. For example, block 1106 to create overlays may be performed on a server that ingests music videos and creates overlays for user video feeds, whereas those overlays may be provided to a client that performs blocks 1108-1116 to show the overlays on a user's feed and track how well the user's movements match them.

At block 1108, process 1100 can begin playback of a second video with the overlay generated at block 1106. In some cases, instead of generating an overlay at block 1106 and showing it at block 1108, process 1100 can simply playback the source video, having the user try to match the motions of the depicted user. In some implementations, the overlay generated at block 1106 can be on provided on the source video, or on another video such as a feed of a second user with the music from the source video (as shown in examples 700 and 800), or on a video of the second user masked to have a different backdrop (e.g., a stage at a rock concert or the source video with the originally depicted user replaced with the second user).

At block 1110, process 1100 can receive posture data for of a second user to which the video from block 1108 is being shown. In various implementations, the posture data can be from the second video; from IMU or other movement/position data of a wearable worn by the second user; from LIDAR, a depth camera, or other motion tracking data from a device monitoring the second user; etc. At block 1112, process 1100 can map a second kinematic model to the posture data for the second user. For example, process 1100 can map points to recognized body parts of the second user depicted in the video received at block 1102 (e.g., accomplished in a manner similar to that performed in block 1104). As another example, movement/position data can be associated with particular body parts, e.g., a watch wearable providing movement data can be defined to be associated with a wrist on which the second user is wearing the watch wearable.

At block 1114, process 1100 can track an accuracy of how well the second kinematic model matches the first kinematic model. In some cases, the matching can be just between parts of the models, such as the parts for the user's hand, arms, head, and/or feet. For example, there can be a match between two kinematic models when both have an arm raised gesture at the same time, no matter what other actions the models are performing at that time. In some implementations, the comparison can be performed thorough distance comparisons of corresponding points when the two models are overlaid on one another or by applying another machine learning model trained to compare similarities between kinematic model postures.

At block 1116, process 1100 can provide scoring based on the tracked accuracy. For example, for each second of matching a score can be provided and those scores can be averaged across the entire time (or segments of time, such as for each level as shown in FIG. 9) that the movement matching model is matching movements between videos. In some implementations, when a score is above a threshold after a set amount of time, the provided score can include progressing the user to a next level, as in a game. Examples of such scoring are provided in 706, 806, and 904 of FIGS. 7-9. Process 1100 can then end.

Aspects of the present disclosure are directed to a video customization system that can customize a video based on a determined focus of the video creator. The video customization system can capture both video and gaze data indicating where the video creator is looking throughout the video. This can be a video captured by a camera, mobile phone, artificial reality device, or other camera-enabled device. The gaze data can, for example, be determined by modeling the user's eye(s) and determining a vector cast out from the center of the user's cornea(s), into the world or onto a screen of the video capture device. In some implementations, this gaze capturing can be done with, or augmented with, one or more machine learning models. By projecting the gaze ray to image coordinates, the video customization system can correlate the gaze data to coordinates in the video, generating time labeled gaze coordinates throughout the video. Based on these coordinates, the video customization system can perform various customizations on the video, such as setting the coordinates as the focal point of the video, recognizing an object at the coordinates, and setting that object as a focus object and/or highlighting the focus object, and/or setting a field-of-view in the video (e.g., cropping the video to the creator's field-of-view or providing an overlay on the video indicating the creator's field-of-view).

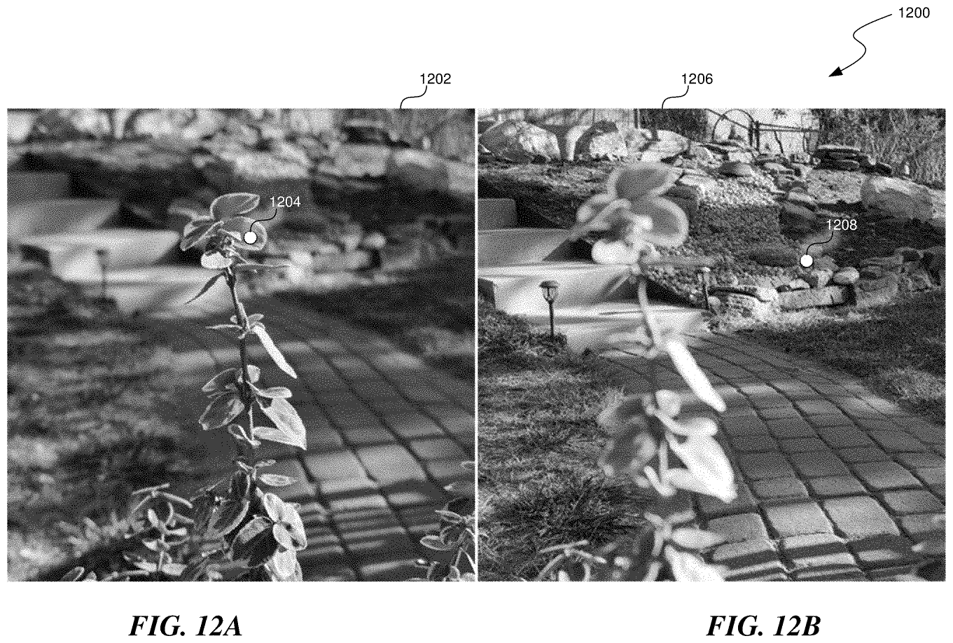

FIGS. 12A and 12B illustrate an example 1200 of video frames with a point focus based on a creator's gaze. In example 1200, video frames 1202 and 1206 are illustrated. In video frame 1202, a creator's gaze has been mapped to point 1204, causing the video customization system to set the vocal distance for that point and to draw an overlay 1202 on the video frame illustrating the creator's focus point. Similarly in video frame 1206, the creator's gaze has been mapped to a new point 1208, causing the video customization system to set the vocal distance for that point and to draw an overlay 1208 on the video frame illustrating the creator's focus.

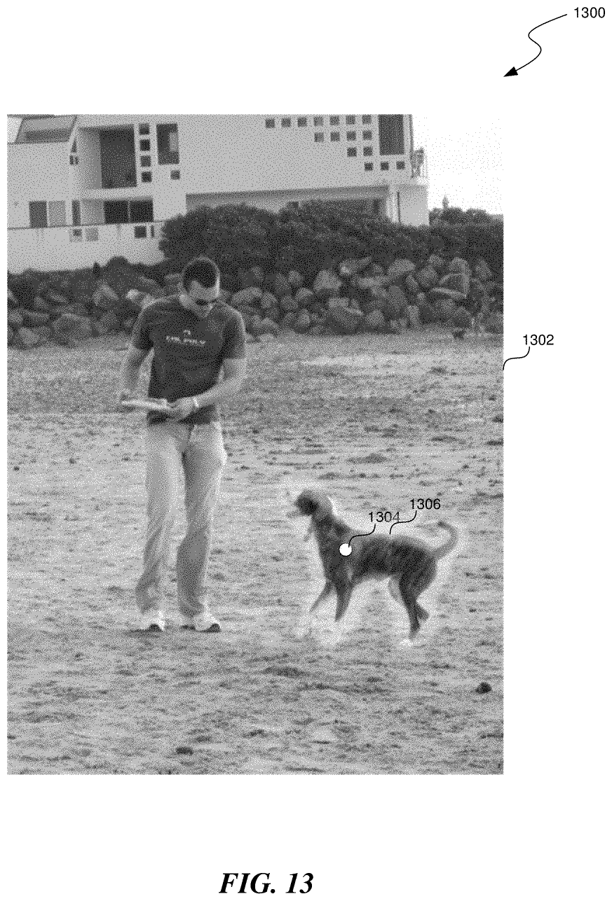

FIG. 13 is an example 1300 of a video frame with an object focus based on a creator's gaze. In example 1300, video frame 1302 is illustrated. In video frame 1302, a creator's gaze has been mapped to point 1304 (in example 1300, the focal point 1304 is shown to demonstrate the creator's focus, but is not actually drawn by the video customization system as an overlay on the video frame). In example 1300 the video customization system recognizes and sets focal objects, thus the video customization system has recognized the dog at the focal point 1304 and, in response, has set a highlighting border 1306 on the dog, demonstrating this is what the video creator was looking at during this frame.

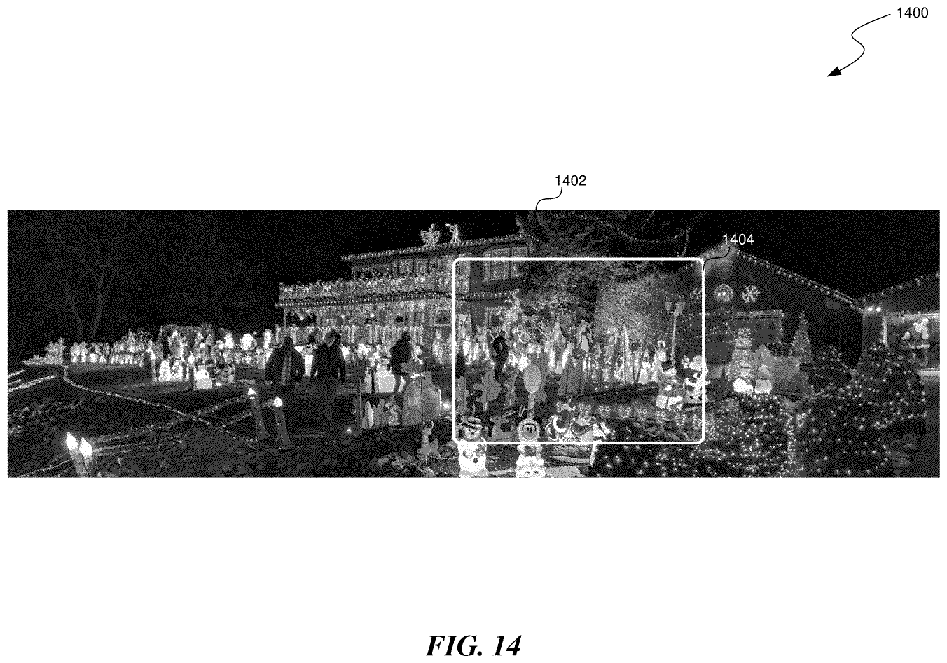

FIG. 14 is an example 1400 of a video frame with a field-of-view set based on a creator's field-of-view. In example 1400, the video customization system is tracking what the video creator can see (her field-of-view) during the video capture process. The video customization system then overlays a border on the video indicating this field-of-view. Example 1400 illustrates a video frame 1402 captured with a panoramic camera, and a border 1404 of the video creator's field of view is overlaid on the frame 1402.

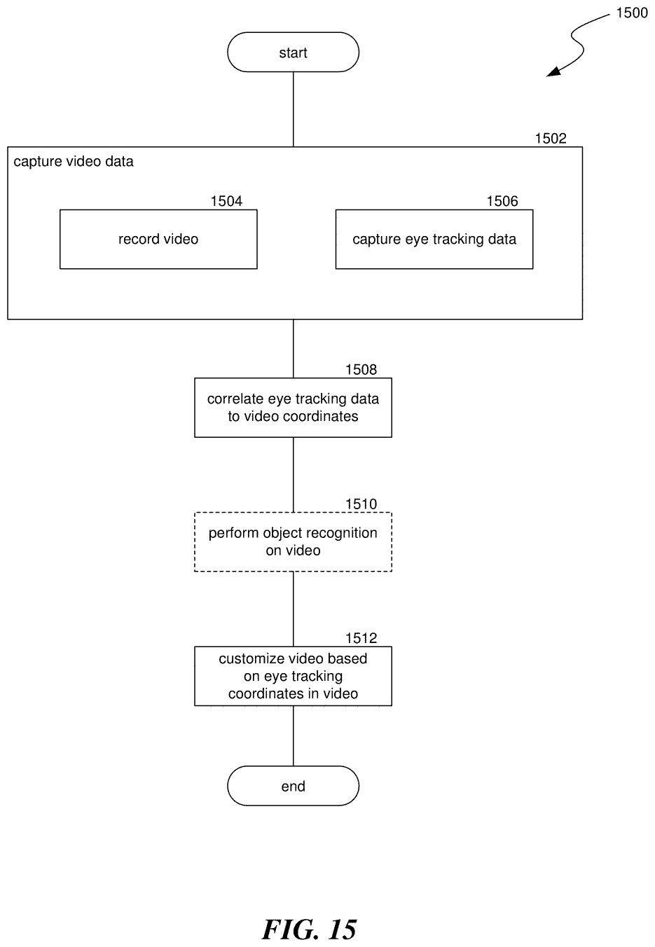

FIG. 15 is a flow diagram illustrating a process 1500 used in some implementations for customizing a video based on a determined focus of the video creator. Process 1500 can be performed in response to a user command to enable focus-point customizations on a video. Process 1500 can be performed on a client or server system, e.g., as the system receives live or pre-recorded video and gaze data. In some implementations, portions of process 1500 can be performed at different times and/or on different computing systems. For example, the capture of video data can be performed by one system while the customization of that video based on the determined focus can be performed on another system (e.g., as post-processing).

At block 1502, process 1500 can capture video data, including visual data (which may be synchronized with audio data) and eye tracking data. The data gathered at block 1502 can be captured (at block 1504 and 1506) by a single device (e.g., an artificial reality device with both external facing camera(s) and user-facing eye tracking cameras) or through time synchronized data from multiple devices such as a first camera capturing the visual data, with a video camera, mobile device, or artificial reality device (at block 1504) with timing information and a second device (e.g., artificial reality device or another camera pointed at the creator's eyes) that captures (at block 1506) gaze data for the creator. In some implementations, the recorded visual data can be a recording of a virtual reality world generated by a computing system, thus the capturing can be capturing the computing system display output, without actually using a physical camera.

The eye tracking data can capture images of the creating user's eyes while one or more light sources illuminate either or both of the user's eyes. An eye-facing camera can capture a reflection of this light to determine eye position (e.g., based on set of reflections, i.e., “glints,” around the user's cornea). In some cases, a 3D model of the user's eyes can be generated such that positions of the eyes are set based on the glints. In some cases, this modeling can be enhanced or replaced through the use of a machine learning module trained to determining a gaze direction or to provide 3D modeling information from glint data inputs. The result can be gaze data that provides, e.g., a ray indicating the direction of a user's gaze in the world or a position on a display where the user was looking at a given time.

At block 1508, process 1500 can correlate the eye tracking data to coordinates in the video. This can include projecting the gaze ray, from the eye tracking data of block 1506, to image coordinates. Block 1508 can include determining how a user's field-of-view maps over the captured video and determining where the user's gaze was directed (based on the captured eye tracking data) within that field of view. This can provide, e.g., coordinates within the video (e.g., from a bottom left corner of the video) where the user's gaze was directed for each frame of the video. This information can be generated for each video frame, resulting in a time series of gazes within the video (that is a map from timestamps to gaze coordinates), conveying where the video creator was looking a the video was captured. Alternatively or in addition, process 1500 at block 1508 can track what the creator's field-of-view was during the video capture. This can be performed, for example, where the captured video is larger than the creator's field-of-view, e.g., for a capture by a panoramic or 1460 degree camera.

While any block can be removed or rearranged in various implementations, block 1510 is shown in dashed lines to indicate there are specific instances where block 1510 is skipped. At block 1510, process 1500 can perform object recognition on the video. This can include recognizing any objects displayed in the video or the object that is at the point of the coordinates determined at block 1508. In some implementations, the object recognition can identify and tag objects while in other cases the object recognition simply determines which parts of a video frame corresponds to an object (i.e., determining object outlines). Object recognition can be performed using existing machine learning models trained for this purpose.

At block 1512, process 1500 can customize the video based on the eye tracking coordinates in the video. In some implementations, the customization can include setting a focal distance in the video (see e.g., FIG. 12)—which may be performed in software on live or pre-recorded video. This may also be performed for live video by mechanically setting the lens focal length on a capturing camera. In some cases, an indicator of the video creator's focal point can also be overlaid onto the video. In some implementations where block 1510 is performed, the customizations can include setting a whole object (which may be a person) as the focus object. This can include making the focus object in focus and may include blurring parts of the video besides the focus object. In some cases, this focus object customization can include adding an indicator to the focus object, such as a highlighting border for the focus object (see e.g., FIG. 13). In some implementations, the video can be a composite from several cameras or from a 1460 degree camera where the video is larger than the field of vide of the video creator. In such cases, the customizations can also or alternatively include cropping the video to be where the creator's field-of-vide was during the video capture; illustrating a frame as an overlay on the video to show the creator's field-of-view (see e.g., FIG. 14); or setting a center point for the video according to the center of the creator's field-of-view.

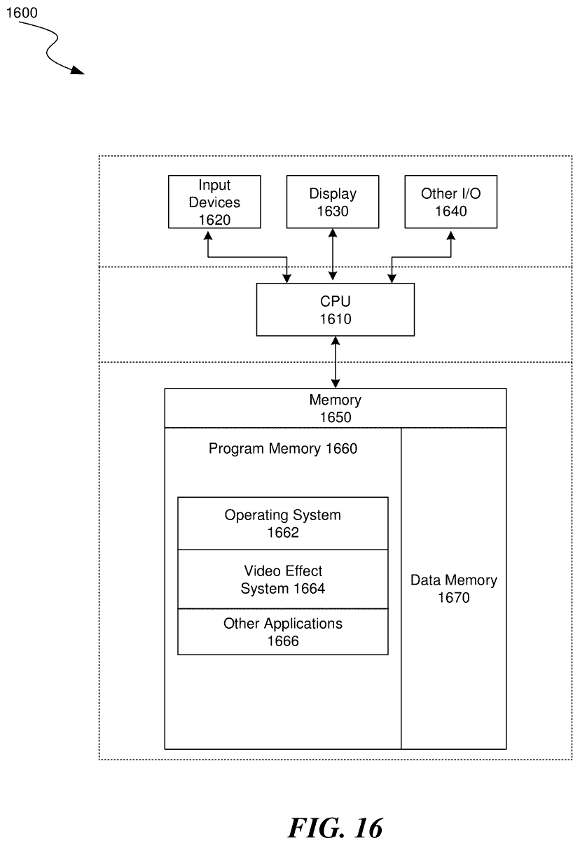

FIG. 16 is a block diagram illustrating an overview of devices on which some implementations of the disclosed technology can operate. The devices can comprise hardware components of a device 1600 as shown and described herein. Device 1600 can include one or more input devices 1620 that provide input to the Processor(s) 1610 (e.g., CPU(s), GPU(s), HPU(s), etc.), notifying it of actions. The actions can be mediated by a hardware controller that interprets the signals received from the input device and communicates the information to the processors 1610 using a communication protocol. Input devices 1620 include, for example, a mouse, a keyboard, a touchscreen, an infrared sensor, a touchpad, a wearable input device, a camera- or image-based input device, a microphone, or other user input devices.

Processors 1610 can be a single processing unit or multiple processing units in a device or distributed across multiple devices. Processors 1610 can be coupled to other hardware devices, for example, with the use of a bus, such as a PCI bus or SCSI bus. The processors 1610 can communicate with a hardware controller for devices, such as for a display 1630. Display 1630 can be used to display text and graphics. In some implementations, display 1630 provides graphical and textual visual feedback to a user. In some implementations, display 1630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1640 can also be coupled to the processor, such as a network card, video card, audio card, USB, firewire or other external device, camera, printer, speakers, CD-ROM drive, DVD drive, disk drive, or Blu-Ray device.

In some implementations, the device 1600 also includes a communication device capable of communicating wirelessly or wire-based with a network node. The communication device can communicate with another device or a server through a network using, for example, TCP/IP protocols. Device 1600 can utilize the communication device to distribute operations across multiple network devices.

The processors 1610 can have access to a memory 1650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1650 can include program memory 1660 that stores programs and software, such as an operating system 1662, video effect system 1664, and other application programs 1666. Memory 1650 can also include data memory 1670, which can be provided to the program memory 1660 or any element of the device 1600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

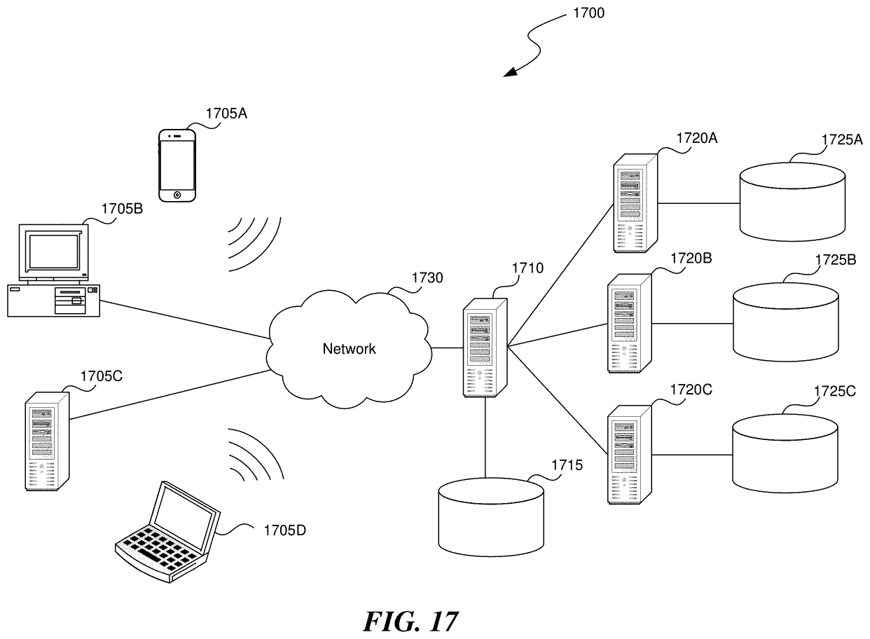

FIG. 17 is a block diagram illustrating an overview of an environment 1700 in which some implementations of the disclosed technology can operate. Environment 1700 can include one or more client computing devices 1705A-D, examples of which can include device 1600. Client computing devices 1705 can operate in a networked environment using logical connections through network 1730 to one or more remote computers, such as a server computing device.

In some implementations, server 1710 can be an edge server which receives client requests and coordinates fulfillment of those requests through other servers, such as servers 1720A-C. Server computing devices 1710 and 1720 can comprise computing systems, such as device 1600. Though each server computing device 1710 and 1720 is displayed logically as a single server, server computing devices can each be a distributed computing environment encompassing multiple computing devices located at the same or at geographically disparate physical locations. In some implementations, each server 1720 corresponds to a group of servers.

Client computing devices 1705 and server computing devices 1710 and 1720 can each act as a server or client to other server/client devices. Server 1710 can connect to a database 1715. Servers 1720A-C can each connect to a corresponding database 1725A-C. As discussed above, each server 1720 can correspond to a group of servers, and each of these servers can share a database or can have their own database. Databases 1715 and 1725 can warehouse (e.g., store) information. Though databases 1715 and 1725 are displayed logically as single units, databases 1715 and 1725 can each be a distributed computing environment encompassing multiple computing devices, can be located within their corresponding server, or can be located at the same or at geographically disparate physical locations.

Network 1730 can be a local area network (LAN) or a wide area network (WAN), but can also be other wired or wireless networks. Network 1730 may be the Internet or some other public or private network. Client computing devices 1705 can be connected to network 1730 through a network interface, such as by wired or wireless communication. While the connections between server 1710 and servers 1720 are shown as separate connections, these connections can be any kind of local, wide area, wired, or wireless network, including network 1730 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed 2/8/2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for determining when a user has made a gesture mapped to an effect and displaying the effect on the video, the method comprising:
receiving at least a portion of a video;
determining that the portion of the video depicts a user making a pose mapped to an effect;
selecting a location for displaying the effect; and
enabling the effect, on the video, at the selected location.

2. A method for matching movements between a source video and a live feed of a second user, the method comprising:
tracking a first user depicted in a source video with a first soundtrack;
generating a corresponding set of kinematic model movements for the first user;
providing an indication of the set of kinematic model movements in a second video with the first soundtrack;
tracking movements of the second user; and
determining an accuracy of a match between the tracked movement of the second user and the set of kinematic model movements.

3. A method for customizing a video based on a determined focus of the video creator, the method comprising:
capturing video and eye tracking data;
correlating the eye tracking data to video coordinates; and
customizing the video based on the eye tracking coordinates.
